(19) United States
(12) Patent Application Publication
(10) Pub. No.: US 2009/0307119 A1
(43) Pub. Date: Dec. 10, 2009

(54) CHECK TRANSMISSION INFORMATION NOTIFICATION SYSTEM FOR FRAUD PREVENTION

(75) Inventors: Daniel Ahles, Houston, TX (US); Bruce Dragt, Atlanta, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/133,244

(22) Filed: Jun. 4, 2008

(51) Int. Cl. G06Q 40/00; G06Q 10/00

(52) U.S. Cl. 705/35

(57) ABSTRACT

A fraud detection system can be implemented by a check processor and a financial institution. The check processor can notify the financial institution proximate to the time a check is submitted to a merchant. The financial institution can then assess whether the check is suspicious and, if suspicious, contact the account holder to confirm that the account holder actually wrote the check. The financial institution can make direct contact with the account holder to confirm that the account holder is aware of the check writing activity.

### CROSS-REFERENCES TO RELATED APPLICATIONS

Not Applicable

### STATEMENT AS TO RIGHTS TO INVENTIONS MADE UNDER FEDERALLY SPONSORED RESEARCH AND DEVELOPMENT

Not Applicable

REFERENCE TO A “SEQUENCE LISTING,” A TABLE, OR A COMPUTER PROGRAM LISTING APPENDIX SUBMITTED ON A COMPACT DISK.

Not Applicable

### BACKGROUND

When checks are used to make a purchase, it can often be several days before the check is processed and settled by the financial institution that maintains the checking account. As a result, if a checkbook is stolen without an account holder's knowledge, the thief can write many bad checks before the account holder or financial institution learns of the theft.

Check processing companies often use several different anti-fraud techniques to analyze checks that are submitted. However, the techniques do not completely prevent fraud from taking place. Thus, check fraud remains a problem worthy of additional countermeasures. Consequently, there is a need for a system that will address this problem.

### SUMMARY

In accordance with one embodiment of the invention, a method of processing a check is provided that comprises receiving at a check processor a notification from a merchant that a check has been presented for payment, wherein the check is associated with a checking account of a financial institution; and sending via a computerized network from the check processor to the financial institution as part of a check fraud detection system a notice that the check has been presented, so as to allow the financial institution to perform check fraud analysis.

In another embodiment of the invention, a method of processing a check comprises receiving at a check processor a notification from a merchant that a check has been presented for payment, wherein the check is associated with a checking account of a financial institution; sending via a computerized network from the check processor to the financial institution as part of a check fraud detection system a notice that the check has been presented; then receiving at the check processor a closed checking account notice from the financial institution indicating that the checking account has been closed.

In still another embodiment of the invention, an apparatus for processing checks comprises a computer for receiving electronic check information corresponding to a check presented to a merchant, wherein the check is associated with a checking account of a financial institution; a software module used by the computer for sending via a computerized network from the computer to the financial institution as part of a check fraud detection system a notice that the check has been presented, so as to allow the financial institution to perform check fraud analysis.

In yet another embodiment of the invention, a method of performing fraud detection comprises receiving at a financial institution via a computerized network a notice from a check processor indicating that a check has been presented for payment, wherein the check is associated with a checking account of the financial institution; performing computerized fraud assessment of the check; in response to the computerized fraud assessment, notifying the account holder of the checking account of suspicious checking account activity.

In another embodiment of the invention, an apparatus for performing fraud detection comprises a computer for receiving a notice from a check processor indicating that a check has been presented for payment, wherein the check is associated with a checking account of a financial institution; a fraud assessment software module coupled with the computer for performing fraud assessment of the check.

Further embodiments of the invention will be apparent from the specification, including the accompanying figures.

### BRIEF DESCRIPTION OF THE DRAWINGS

FIG. 1 illustrates a block diagram of a network for detecting a fraudulent check transaction in accordance with one embodiment of the invention.

FIG. 2 illustrates a block diagram of a computer for use in FIG. 1 in accordance with one embodiment of the invention.

FIG. 3 illustrates a flowchart demonstrating a method of processing a check presented to a merchant, in accordance with one embodiment of the invention.

FIG. 4 illustrates a flowchart demonstrating a method of processing a check by a check processor in accordance with one embodiment of the invention.

FIG. 5 illustrates a flowchart demonstrating a method of performing fraud detection by a financial institution in accordance with one embodiment of the invention.

FIG. 6 illustrates a flowchart demonstrating a method of fraud detection by a financial institution in accordance with another embodiment of the invention.

### DETAILED DESCRIPTION

When a sale is transacted at a merchant, a customer will often pay with a check. Merchants will often use a check processor, such as third party check processor Telecheck Inc. of Houston, Tex., to perform a risk analysis of the check prior to accepting the check. The risk analysis assists the merchant in deciding whether to accept or decline the check.

Check processors currently have no way of contacting a check writer/account holder when they analyze the risk associated with a check submitted for review by a merchant. While the check processor can use its various databases to check for negative or positive history in regard to the checking account, the check processor has no ability to contact the account holder directly. This is due to the fact that the information that the check processor typically receives for a transaction is the check amount and the information that identifies the checking account. No contact information for the account holder is typically supplied to the check processor at the time of sale.

Furthermore, the check processor typically has the business relationship with the merchant that receives the check rather than with the check writer/account holder. Therefore, there is no pre-established contact information that the check processor has with the account holder.

A financial institution that maintains the checking account for an account holder, however, does keep contact information. Thus, in accordance with one embodiment of the invention, a system is provided to allow a financial institution to contact a checking account holder about checking account activity proximate in time to a check being presented. This embodiment allows a financial institution to identify suspicious check writing activity and to prevent additional fraudulent checks from being presented. It is intended that “suspicious” checking account activity shall include unusual, out of the ordinary, unexpected, and/or possibly fraudulent checking account activity.

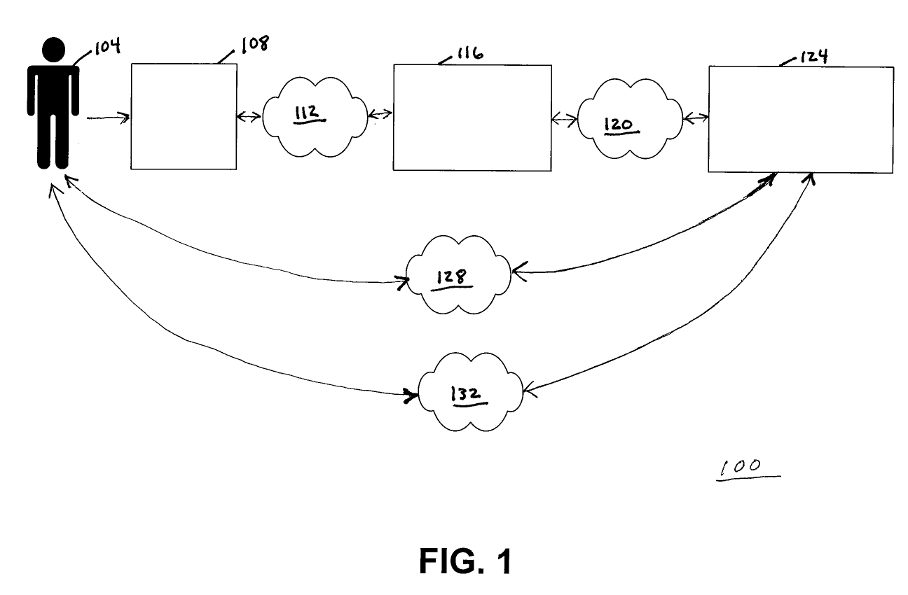

Referring now to FIG. 1 a system 100 is shown. In FIG. 1, a customer 104 presents a check for payment to a merchant 108. The merchant can be any type of business that accepts checks for payment. The merchant employs a third party check processor 116 to assess the risk of accepting different checks from different consumers. Such analysis can be performed for example by checking negative databases about the checking account and the amount that the check is made payable. Similarly, positive databases can also be checked. After performing this risk analysis, the check processor 116 can notify merchant as to whether the check in question is approved or not. The inquiry to the check processor from the merchant can be made across a network 112, such as a computerized network. Network 112 allows the transmission of financial information concerning the check and even the check writer to be transmitted to the check processor.

In accordance with one embodiment of the invention, the check processor can then forward the check information to the financial institution that maintains the checking account for the check. This can be accomplished by transmitting the received information from the check processor 1 16 to the financial institution 124 across network 120. The check processor can send the information to the financial institution at the time it is received from the merchant or at a later point in time. For example, the check processor might choose to send the check information to the financial institution as part of a batch process at the end of each day. However, the earlier the financial institution can receive the information concerning checks that have been written, the earlier the financial institution can perform its own fraud analysis and detect possible fraudulent activity.

Upon receiving information about a check that has been presented, the financial institution can perform a risk analysis. This could be accomplished for example by comparing the amount of the check against the checking account holder's previous check writing activity. If the amount of the check is significantly higher than the amount that checks on the checking account are typically written for, then the risk analysis software program can flag the check as potentially fraudulent. Obviously, other types of risk analysis programs can be performed as well. Upon flagging a check, the present embodiment of the invention now allows for the account holder to be contacted. In the past, the system did not allow for the account holder to be contacted proximate in time to when the check was first presented. However, in accordance with this embodiment, the account holder may now be contacted by the financial institution. This can be accomplished for example by communicating the flagged check to a customer service employee. The customer service employee can then contact the account holder using contact information. For example, the customer service representative could telephone the account holder 104 via telephone network 128 using a telephone number associated with the checking account. Or, the customer service representative could use some other form of electronic communication, such as sending an email via network 132.

The account holder can be notified that a suspicious check has been presented. The notice might indicate the specific merchant where the check was presented, the date and time of day the check was presented, the amount of the check, and/or other information specific to the transaction. The account holder can be notified of who to contact if the check was not actually written by the account holder. Thus, the account holder can be supplied with an opportunity to stop fraudulent check writing from continuing prior to receiving a monthly statement as to the activity on a checking account.

If the account holder responds to the financial institution, the financial institution can take appropriate measures. Namely, if the account holder indicates that he/she did not write the check, then the financial institution can take remedial action. For example, the financial institution can close the account, notify all third party check processors that the checking account has been closed, and notify law enforcement personnel. The financial institution can also open a new checking account for its customer to replace the closed account. Furthermore, the financial institution can notify the check processors that the old checking account is suspected of being associated with fraudulent activity.

As a result, a check processor will now be in a better position to not approve a second fraudulent check written on stolen checks. This prevents fraud from occurring and funds being stolen via fraudulent checks. It allows earlier prevention of continued fraudulent activity on a checking account.

In one embodiment of the invention, the financial institution receives information not only about checks that have been approved by the check processor but also information about checks that have not been approved by the check processor. Thus, in the past, a financial institution would only have received information about a check after it had been accepted by a merchant and submitted by the merchant for settlement. In the present embodiment, the financial institution receives information about all checks that have been submitted for a particular checking account. If stolen checks are being written for extremely large amounts and consequently are being declined, the financial institution is in a much better position to detect this fraudulent activity by being made aware of all checks that are being written on a checking account.

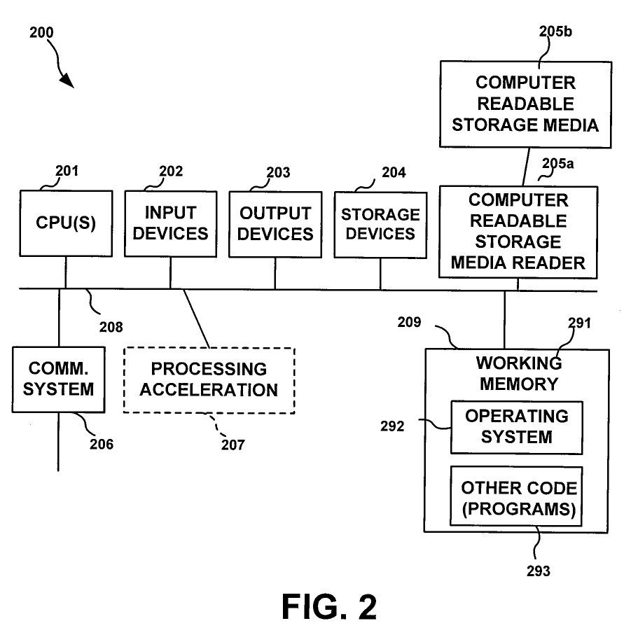

The computer implemented devices shown in FIG. 1 can be implemented using a system such as that shown in FIG. 2. System 200 is shown comprised of hardware elements that are electrically coupled via bus 208, including a processor 201, input device 202, output device 203, storage device 204, computer-readable storage media reader 205a, communications system 206 processing acceleration (e.g., DSP or special-purpose processors) 207 and memory 209. Computer-readable storage media reader 205a is further coupled to computer-readable storage media 205b, the combination comprehensively representing remote, local, fixed and/or removable storage devices plus storage media, memory, etc. for temporarily and/or more permanently containing computer-readable information, which can include storage device 204, memory 209 and/or any other such accessible system 200 resource. System 200 also comprises software elements (shown as being currently located within working memory 291) including an operating system 292 and other code 293, such as programs, applets, data and the like.

System 200 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 200 component (e.g. within communications system 206). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized.

Different software modules can be utilized in system 200. For example, a software module can be used that causes the computer of the check processor to send to the financial institution a notice that the check has been presented, so as to allow the financial institution to perform check fraud analysis. The software module can add the information received from the merchant as well as time and date information and the name of the merchant that received the check. The software module can cause the computer to send the notice as an individualized notice to the financial institution upon receiving the electronic check information from the merchant or send the notice as part of a batch process.

Similarly, the computer used by the financial institution can include a fraud assessment software module coupled with the computer for performing fraud assessment of the check. Also, a notification software module can be used by the financial instituion for use in reporting to the account holder in response to the fraud assessment software module that suspicious checking account activity has taken place. For example, the notification software module can be configured to send an email to the account holder. The notification software module can also be used to report to the check processor that the checking account has been closed.

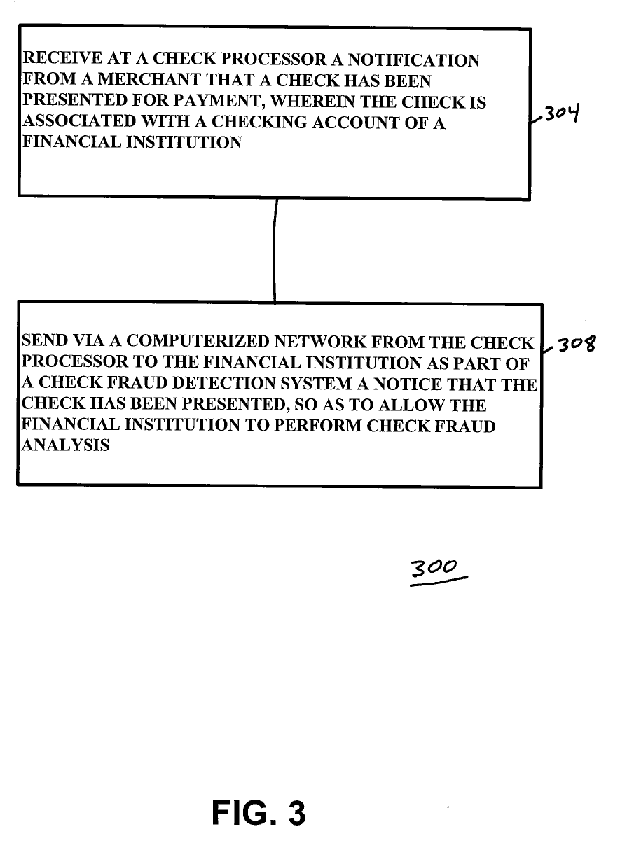

Referring now to FIG. 3, a flowchart 300 illustrates a method of performing check processing by a check processor in accordance with one embodiment of the invention. In flowchart 300, block 304 shows that a check processor can receive a notification from a merchant that a check has been presented for payment. The check is associated with a checking account of a financial institution, such as a bank. In block 308, the check processor then sends a notice to the financial institution that the check has been presented. The notice is sent from the check processor to the financial institution via a computerized network. The system allows fraud detection to be performed in that the information received by the financial institution can be used for fraud analysis.

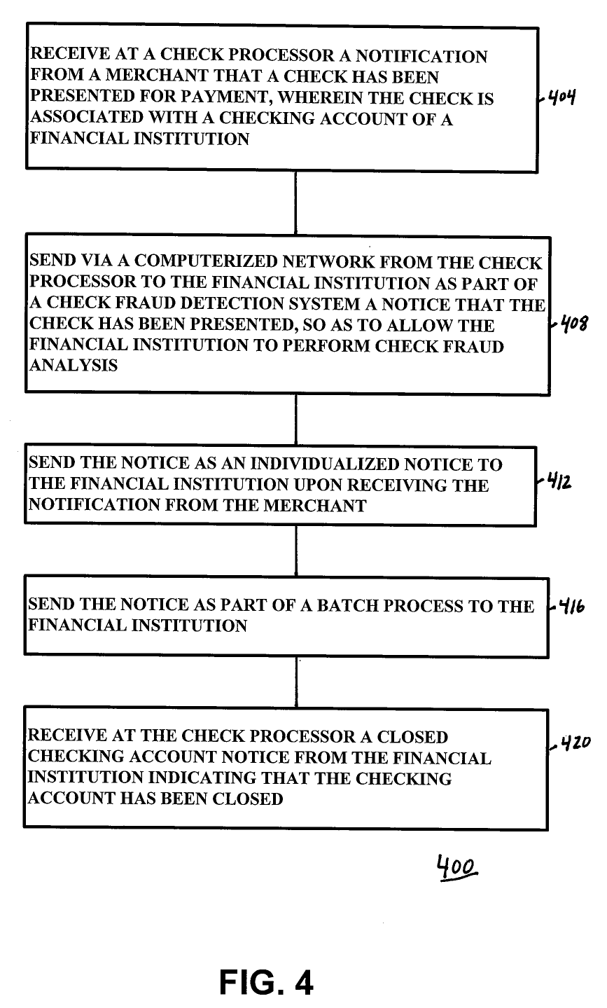

FIG. 4 illustrates another embodiment of how the check processor can participate as part of a fraud detection system. In block 404 of flowchart 400, a check processor receives notification from a merchant that a check has been presented for payment. The check is associated with a checking account of a financial institution. In block 408, the check processor sends to the financial institution a notice that the check has been presented. A computerized network can be used to transmit the information. The information can be sent to allow the financial institution to perform check fraud analysis.

In block 412, the notice can be sent as part of an individualized notice. For example, this can be accomplished by relaying the information received from the merchant immediately to the financial institution upon receipt. Alternatively, block 416 illustrates that a batch process could be used to send the notice to the financial institution. Thus, for example, at the end of each work day the various checks that have been received by a check processor for a financial institution's checking accounts can be sent as a batch transmission to the financial institution for fraud analysis. In some instances, possible check fraud will be detected. Thus, it will be necessary for the financial institution to close the checking account in question. In such an instance, the financial institution can notify the check processor that the checking account has been closed and that no further checks should be approved for that account. This is shown in block 420.

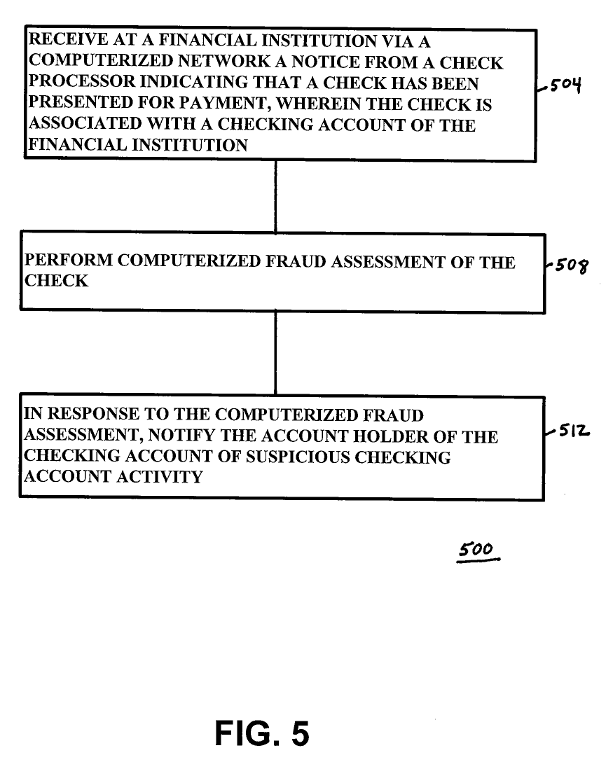

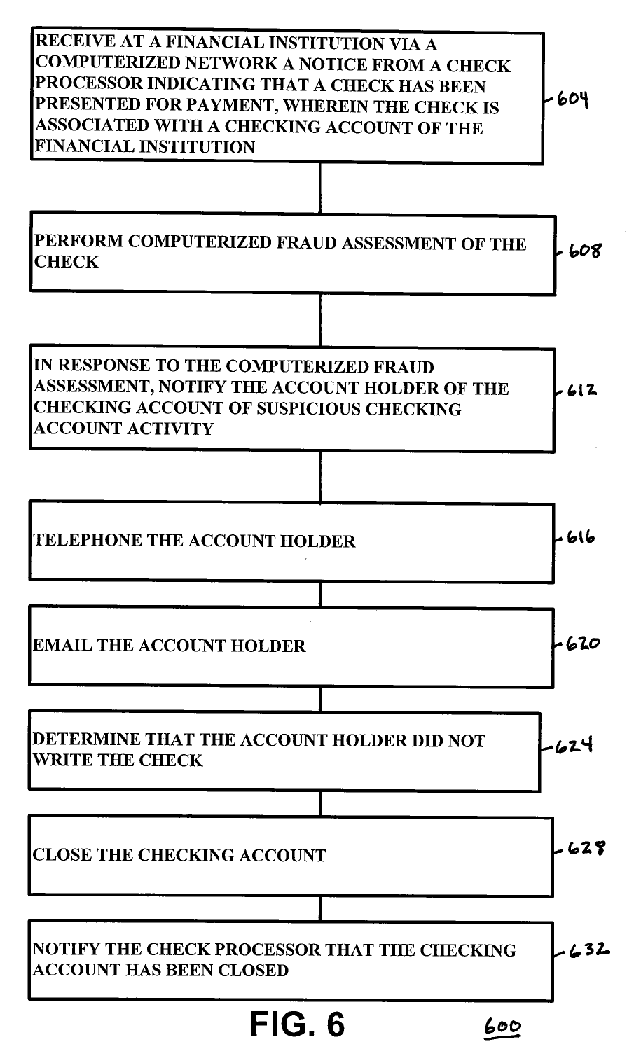

FIGS. 5 and 6 illustrate embodiments of the invention from the perspective of the financial institution. In flowchart 500, a financial institution receives via a computerized network a notice from a check processor. The notice indicates that a check has been presented for payment. The check is associated with a checking account of the financial institution. The financial institution can then use the information from the notice to perform a computerized fraud assessment of the check, as shown by block 508. If the computerized fraud assessment indicates a suspicion of fraudulent activity, then the checking account holder can be notified, as shown in block 512.

In block 604 of FIG. 6, a financial institution receives via a computerized network a notice from a check processor. The notice indicates that a check has been presented for payment at a merchant. The check is associated with a checking account of the financial institution. In block 608, a computerized fraud assessment is performed by the financial institution based on the notice received from the check processor. If suspicious checking account activity is detected, by the computerized fraud assessment, then the account holder can be notified, as shown by block 612. For example, block 616 illustrates that the financial institution can telephone the account holder while block 620 shows that the financial institution can email the account holder. Other means of communication can be used as well to notify the account holder. After notifying the account holder, a determination can be made as to whether the account holder actually wrote the check, as shown by block 624. This can be accomplished for example by receiving an email reply to the financial institution from the account holder that the check was not actually written by the account holder and that the account holder would like the financial institution to stop payment on all checks for that account or close the account, as shown by block 628, and open a new account for the customer. Furthermore, block 632 illustrates that the financial institution can follow up with various check processors to notify them that the checking account has been closed.

While the above system has been described generally in terms of a fraud prevention system for checking accounts, it could be generalized for ACH transactions. For example, it could be utilized by an ACH originator, such as third party check processor Telecheck. Upon receiving notification from a merchant that a form of payment has been presented for submission as an ACH debit to the ACH system, the ACH originator could contact the financial institution directly via a computerized network to notify the financial institution of the ACH debit. This would allow the financial institution to obtain notice of the ACH debit prior to the ACH system actually completing processing of the ACH debit and notifying the financial institution itself. As a result, the financial institution can detect fraudulent transactions sooner and take steps to remediate the problem sooner. In some instances, the financial institution can contact the customer directly so as to confirm by correspondence with the customer that no fraud is taking place. Also, the financial institution can alert the ACH originator if possible fraud has been detected. Such a system could be implemented for any ACH transaction, including ACH based card transactions.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well. Furthermore, the embodiments of the invention may be embodied as code stored in a computer-readable memory of virtually any kind including, without limitation, RAM, ROM, magnetic media, optical media, or magneto-optical media. Even more generally, the embodiments of the invention could be implemented in software, or in hardware, or any combination thereof including, but not limited to, software running on a general purpose processor, microcode, PLAs, or ASICs.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or step for performing a function. Therefore, it should be understood that such language is entitled to cover all such structures, materials, or acts disclosed within this specification and their equivalents, including the matter incorporated by reference.

It is thought that the apparatuses and methods of embodiments of the present invention and its attendant advantages will be understood from this specification. While the above description is a complete description of specific embodiments of the invention, the above description should not be taken as limiting the scope of the invention as defined by the claims.

1. A method of processing a check, the method comprising:
receiving at a check processor a notification from a merchant that a check has been presented for payment, wherein the check is associated with a checking account of a financial institution;
in response to the notification from the merchant, sending via a computerized network from the check processor to the financial institution as part of a check fraud detection system a notice that the check has been presented, so as to allow the financial institution to perform check fraud analysis.

2. The method as claimed in claim 1 wherein the sending the notice to the financial institution comprises:
sending the notice as an individualized notice to the financial institution upon receiving the notification from the merchant.

3. The method as claimed in claim 1 wherein the sending the notice to the financial institution comprises:
sending the notice as part of a batch process to the financial institution.

4. A method of processing a check, the method comprising:
receiving at a check processor a notification from a merchant that a check has been presented for payment, wherein the check is associated with a checking account of a financial institution;
in response to the notification from the merchant, sending via a computerized network from the check processor to the financial institution as part of a check fraud detection system a notice that the check has been presented; then
receiving at the check processor a closed checking account notice from the financial institution indicating that the checking account has been closed.

5. The method as claimed in claim 4 wherein the notice sent to the financial institution by the check processor comprises the payable amount for the check and information specifying the checking account.

6. A method of performing fraud detection, the method comprising:
receiving at a financial institution via a computerized network a notice from a check processor indicating that a check has been presented for payment, wherein the check is associated with a checking account of the financial institution;
in response to the notice from the check processor, performing computerized fraud assessment of the check;
in response to the computerized fraud assessment, notifying the account holder of the checking account of suspicious checking account activity.

7. The method as claimed in claim 6 and further comprising:
determining that the account holder did not write the check.

8. The method as claimed in claim 6 and further comprising:
closing the checking account.

9. The method as claimed in claim 6 and further comprising:
notifying the check processor that the checking account has been closed.

10. The method as claimed in claim 6 wherein the notifying the account holder comprises:
telephoning the account holder.

11. The method as claimed in claim 6 wherein the notifying the account holder comprises:
emailing the account holder.

12. An apparatus for processing checks, the apparatus comprising:
a computer for receiving electronic check information corresponding to a check presented to a merchant, wherein the check is associated with a checking account of a financial institution;
a software module used by the computer for sending via a computerized network from the computer to the financial institution as part of a check fraud detection system a notice that the check has been presented, so as to allow the financial institution to perform check fraud analysis.

13. The apparatus as claimed in claim 12 wherein the software module causes the computer to send the notice as an individualized notice to the financial institution upon receiving the electronic check information from the merchant.

14. The apparatus as claimed in claim 12 wherein the software module causes the computer to send the notice as part of a batch process to the financial institution.

15. The apparatus as claimed in claim 12 wherein the computer comprises:
a closed checking account software module for receiving notification from the financial institution indicating that the checking account has been closed.

16. The apparatus as claimed in claim 15 wherein the notice sent to the financial institution by the check processor comprises the payable amount for the check and information specifying the checking account.

17. An apparatus for performing fraud detection, the apparatus comprising:
a computer for receiving a notice from a check processor indicating that a check has been presented for payment, wherein the check is associated with a checking account of a financial institution;
a fraud assessment software module coupled with the computer for performing fraud assessment of the check.

18. The apparatus as claimed in claim 17 and further comprising:
a notification software module for use in reporting to the account holder in response to the fraud assessment software module that suspicious checking account activity has taken place.

19. The apparatus as claimed in claim 17 wherein the notification software module is also used to report to the check processor that the checking account is closed.

20. The apparatus as claimed in claim 18 wherein the notification software module is configured to send an email to the account holder.

21. A method of detecting fraud for an ACH debit transaction, the method comprising:
receiving at an ACH originator a notification from a merchant that a form of payment has been presented for payment, wherein the form of payment is associated with an account of a financial institution;
in response to receiving said notification from said merchant, sending via a computerized network from the ACH originator to the financial institution as part of a fraud detection system a notice that an ACH debit has been presented for the ACH system, so as to allow the financial institution to perform a fraud analysis on the ACH debit prior to completion of processing of the ACH debit by the ACH system.
